(19) United States
(12) Patent Application Publication
(10) Pub. No.: US 2013/0091052 A1
(43) Pub. Date: Apr. 11, 2013

(54) SYSTEMS AND METHODS FOR GENERATING NEW ACCOUNTS WITH A FINANCIAL INSTITUTION

(71) Applicants: Paal KAPERDAL, Mississauga (CA); Elena FLOM, Mississauga (CA)

(72) Inventors: Paal KAPERDAL, Mississauga (CA); Elena FLOM, Mississauga (CA)

(21) Appl. No.: 13/269,314

(22) Filed: Oct. 7, 2011

(51) Int. Cl. G06Q 40/02

(52) U.S. Cl. 705/39

(57) ABSTRACT

Systems, methods and computer programming for evaluating users applying for a new account with a financial institution, and generating the new account online, are described. The request, identity information and geographic information are received by the financial institution over a network from the user, and confidence scores are generated and evaluated by the financial institution. If a temporary limited account is approved for generation, then an online transfer of funds from an existing account with another financial institution is initiated and completed by to complete the new account generation.

### FIELD OF INVENTION

This invention relates generally to conducting financial transactions, and more specifically to systems and methods for generating new accounts with a financial institution.

### SUMMARY OF THE INVENTION

In an aspect of the present invention, a method online generating a financial account with a financial institution is provided, the method comprising: receiving over a computing network a request from a user at a user workstation at an account generation server of the financial institution to open a new financial account with the financial institution, the user not having an existing financial account with the financial institution; receiving over the network at the account generation server identity information regarding the user, the account generation server evaluating the identity information to generate an identity confidence score; receiving over the network at the account generation server geographic information regarding the user, the account generation server evaluating the geographic information to generate a geographic confidence score; generating a set of user-specific questions from the received identity information, and requesting responses over the network from the user to the set of user-specific questions; receiving over the network at the account generation server the responses from the user to the set of user-specific questions, the account generation server evaluating the responses to adjust the identity confidence score; the account generation server generating a user overall confidence score based on the identity confidence score and the geographic confidence score; and the account generation server evaluating whether the user overall confidence score is over a confidence threshold such that the financial account with the financial institution may be generated, and if so, the account generation server: generating the financial account with limited status associated with the user, the financial account with limited status only permitting the deposit of funds to the limited account; requesting the user transfer funds into the new financial account from another account with another financial institution over the network; receiving transferred funds over the network from another account with another financial institution; updating the financial account from limited status to regular status, wherein other functions of the financial account beyond only deposit of funds to the account are activated; and sending a message to the user at the workstation that the new financial account has been generated and ready for use by the user.

In some embodiments, the step of receiving transferred funds from another account with another financial institution can further comprise: providing the user with the option to select the another financial institution with whom the user has an existing account, from among a selection of financial institutions; maintaining the request for the financial account with the financial institution active at the account generation server for a predetermined period of time, while awaiting confirmation from the another financial institution that the user has authorized a transfer of funds to the financial institution, and that the another financial institution has approved the transfer of funds; and at least one of receiving the transferred funds, or receiving a transaction confirmation for later reconciliation, from the another financial institution by the financial institution within the predetermined period of time.

In some embodiments, the option to select the another financial institution with whom the user has an existing account is provided by neither the financial institution nor the another financial institution, but can be provided by an intermediary entity utilized by both the financial institution and the another financial institution to permit the financial institution to receive the transferred funds from the another financial institution through the intermediary entity, wherein the at least one of receiving the transferred funds, or receiving the transaction confirmation for later reconciliation by the financial institution, can be received from the intermediary entity.

In some embodiments, the intermediary entity can provide the transferred funds to be received by the financial institution, and can receive the corresponding funds from the another financial institution.

In some embodiments, the generation of the user overall confidence score can further comprise determining a weighted average of the identity confidence score and the geographic confidence score.

In some embodiments, the geographic information can comprise information relating to the access location of the user, and the generation of the geographic confidence score can comprise determining if the access location of the user is associated with high risks of fraudulent activity.

In some embodiments, the generation of the identity confidence score can further comprise obtaining known information regarding the user based on the identity information of the user, and determining if there are inconsistencies between the known information and the received identity information.

In some embodiments, the known information can further identify additional facts relating to the user than the identity information, and the step of generating the set of user-specific questions can further comprise generating the set of user-specific questions based on the additional facts relating to the user.

In some embodiments, the step of confirming that the user has authorized the transfer of funds can include the receipt of magnetic ink character recognition (MICR) information from the user.

In some embodiments, the MICR information can be provided to a MICR server to verify the MICR information, including that the existing account with the another financial institution as specified by the MICR information is consistent with the received identity information of the user, and that adequate funds are available in the existing account.

In a further aspect of the present invention, a non-transitory computer readable medium for storing a set of programming instructions for execution by, or on behalf of, an account generation server associated with a financial institution for evaluating a user for a new financial account with the financial institution and for generating the financial account, wherein the user does not have an existing financial account with the financial institution is provided, having programming instructions for causing the account generation server to: receive over a computing network in communication with the account generation server from the user at a user workstation communicating with the network a request to open the new financial account with the financial institution; receive over the network at the account generation server identity information regarding the user and geographic information regarding the user and the workstation; evaluate the identity information to generate an identity confidence score, and evaluate the geographic information to generate a geographic confidence score; generate a set of user-specific questions from the received identity information, and requesting responses over the network from the user to the set of user-specific questions; receive over the network the responses from the user to the set of user-specific questions, and evaluate the responses to adjust the identity confidence score; generate a user overall confidence score based on the identity confidence score and the geographic confidence score; and evaluate whether the user overall confidence score is over a confidence threshold such that the financial account with the financial institution may be generated, and if so: generate the financial account with limited status at the financial institution to be associated with the user, the financial account with limited status only permitting the deposit of funds to the limited account; request the user transfer funds into the new financial account from another account with another financial institution over the network; receive transferred funds over the network from another account with another financial institution; updating the financial account from limited status to regular status, wherein other functions of the financial account beyond only deposit of funds to the account are activated; and send a message to the user at the workstation that the new financial account has been generated and is ready for use by the user.

In some embodiments, the programming instructions can further cause the account generation server to: provide the user with the option to select the another financial institution with whom the user has an existing account, from among a selection of financial institutions; maintain the request for the financial account with the financial institution active at the account generation server for a predetermined period of time, while awaiting confirmation from the another financial institution that the user has authorized a transfer of funds to the financial institution, and that the another financial institution has approved the transfer of funds; and receive at least one of the transferred funds, or a transaction confirmation for later reconciliation, from the another financial institution by the financial institution within the predetermined period of time.

In some embodiments, the computer readable medium can have further programming instructions for causing the account generation server to provide the option to select the another financial institution with whom the user has an existing account to be provided by neither the financial institution nor the another financial institution, and for causing the account generation server to communicate with an intermediary entity in communication with the another financial institution to permit the financial institution to receive the transferred funds from the another financial institution through the intermediary entity, wherein the received at least one of the transferred funds, or the transaction confirmation for later reconciliation by the financial institution, can be received by the account generation server from the intermediary entity.

In some embodiments, the computer readable medium can have further programming instructions for causing the account generation server to generate the user overall confidence score by at least determining a weighted average of the identity confidence score and the geographic confidence score.

In some embodiments, the geographic information can further comprise information relating to the access location of the user, and the computer readable medium can have further programming instructions that can generate the geographic confidence score by at least determining if the access location of the user is associated with high risks of fraudulent activity.

In some embodiments, the computer readable medium can have father programming instructions for causing the account generation server to generating the identity confidence score by at least by obtaining known information regarding the user based on the identity information of the user, and for determining if there are inconsistencies between the known information and the received identity information.

In some embodiments, the known information can further identify additional facts relating to the user than the identity information, and the computer readable medium can have further programming instructions for causing the account generation server to generating the set of user-specific questions by at least generating the set of user-specific questions based on the additional facts relating to the user.

In some embodiments, the computer readable medium can have further programming instructions for causing the account generation server to obtain magnetic ink character recognition (MICR) information from the user in respect of the existing account at the another financial institution.

In some embodiments, the computer readable medium can have further programming instructions for causing the account generation server to provide the received MICR information to a MICR server to verify the MICR information, including that the existing account with the another financial institution as specified by the MICR information is consistent with the received identity information of the user, and that adequate funds are available in the existing account.

In another aspect of the present invention, a system is provided for evaluating a user and generating a financial account with a financial institution, the system comprising: an account generation server associated with the financial institution, the account generation server having a new account module for communication with the user who does not have an existing financial account with the financial institution at a user workstation over a computing network, the new account module receiving a request from the user through the workstation and network to open a new financial account with the financial institution, whereupon the new account module obtains from the user workstation geographic information regarding the user and the user workstation, and identity information regarding the user; a user evaluation module associated with the account generation server in communication with the new account module, the user evaluation module receiving the geographic information, evaluating the geographic information and generating a geographic confidence score therefrom, and receiving the identity information, evaluating the identity information and generating an identity confidence score therefrom, the user evaluation module further using the received identity information to generate a set of user-specific questions, and requesting responses over the network from the user to the set of user-specific questions; the user evaluation module receiving the responses from the user to the set of user-specific questions, and evaluating the responses to adjust the identity confidence score, and generating a user overall confidence score based on the adjusted identity confidence score and the geographic confidence score; and the user evaluation module evaluating whether the user overall confidence score is over a confidence threshold such that the financial account with the financial institution may be generated, and if so, having the account generation server to: generate the financial account with limited status associated with the user, the financial account with limited status only permitting the deposit of funds to the limited account; request the user transfer funds into the new financial account from another account with another financial institution over the network; receive transferred funds over the network from another account with another financial institution; update the financial account with limited status to regular status, wherein other functions of the financial account beyond only deposit of funds to the account are activated; and send a message to the user at the workstation that the new financial account has been generated and ready for use by the user.

### BRIEF DESCRIPTION OF THE DRAWINGS

For a better understanding of embodiments of the system and methods described herein, and to show more clearly how they may be carried into effect, reference will be made by way of example, to the accompanying drawings in which:

FIG. 1 shows an embodiment of a system for creating an account with a financial institution for a user;

FIG. 2 shows an embodiment of a method for creating an account with a financial institution for a user using the system shown in FIG. 1;

FIG. 3 shows an embodiment of a process for generating a confidence score representative of the confidence a financial institution has that a user opening a new account is the individual who they are claiming to be;

FIG. 4 shows an alternative embodiment of a process for generating a confidence score representative of the confidence a financial institution has that a user opening a new account is the individual who they are claiming to be;

FIG. 5 shows an embodiment for generating a geographic confidence score based on geographic information obtained from a user;

FIG. 6 shows an embodiment for authorizing, initiating, conducting and verifying a transaction between a financial institution where a user is opening a new account and a financial institution the user has a pre-existing account with; and

FIGS. 7A-7C show an alternative embodiment for authorizing, initiating, conducting and verifying a transaction between a financial institution where a user is opening a new account and a financial institution the user has a pre-existing account with.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. In an embodiment these systems and methods are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, tablet, mobile device, personal data assistant, or wireless network device. Program code is applied to input data to perform the functions described herein and generate output information. The output information may be applied to one or more output devices. The embodiments described herein includes computer readable medium for storing a set of programming instructions for execution by computer processors.

Each program can be implemented in a high level procedural or object oriented programming and/or scripting language to communicate with a computer system. However, the programs can be implemented in assembly or machine language, if desired. In any case, the language may be a compiled or interpreted language. Each such computer program can be stored on a storage media or a device (e.g. ROM, flash or magnetic diskette) readable by a general or special purpose programmable computer, for configuring and operating the computer when the storage media or device is read by the computer to perform the procedures described herein. The embodiments may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable programmatic instructions for one or more processors. The medium may be provided in various forms, including one or more diskettes, compact disks, tapes, chips, wireline or wireless transmissions, satellite transmissions, internet transmission or downloads, magnetic and electronic storage media, digital and analog signals, and the like. The computer useable instructions may also be in various forms, including compiled and non-compiled code.

In various embodiments described below, there are systems and methods described for evaluating, generating and providing financial accounts to users in a computer network. Such embodiments tend to be advantageous in permitting a user to apply for, qualify, and receive an new account with a financial institution with which the user has had no or only limited interaction with in the past.

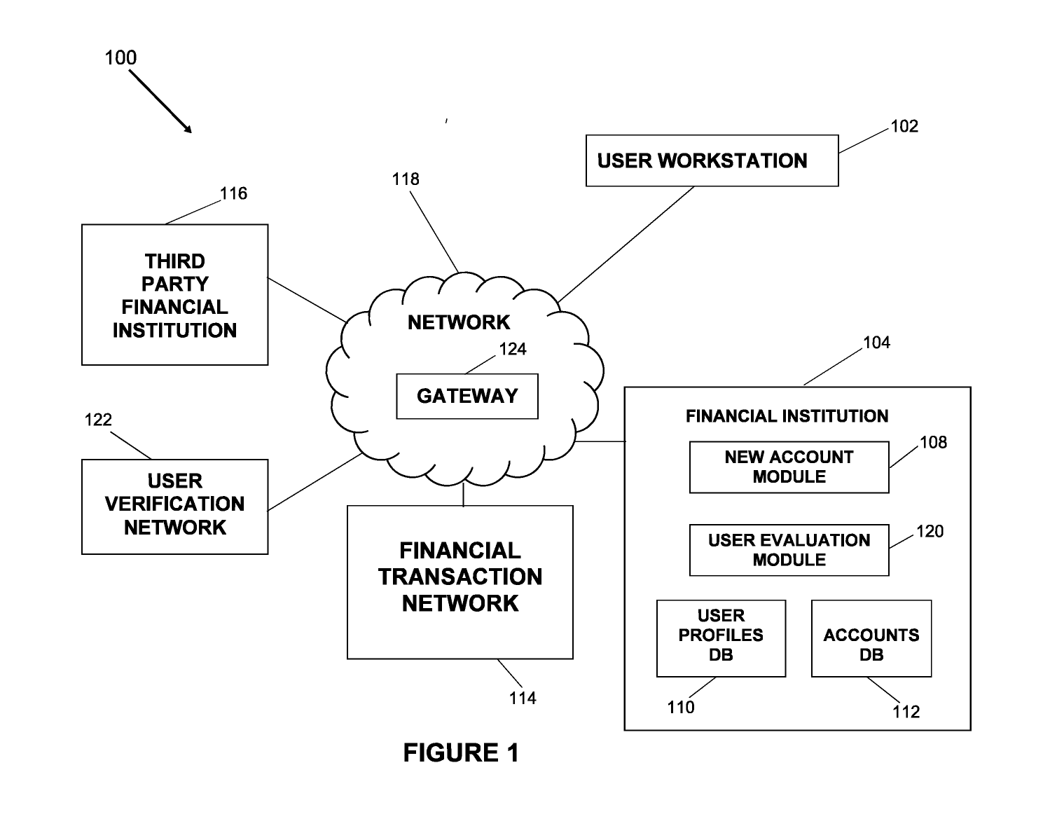

Referring to FIG. 1, system 100 is shown in an exemplary embodiment for creating an account with a financial institution for a user. Such a user may be a new or existing customer with a financial institution. Although in the description below, the embodiments are described with respect to operation for new customers to a financial institutions, the systems and processes describe herein may also be operated with respect to existing customers for a financial institution.

System 100 has user workstation 102, financial institution 104, financial transaction network 114, third party financial institution 116 and user verification network 122, each of which are able to communicate with each other through network 118.

In some embodiments, network 118 can be a local area network, wide area network, the Internet, or any other communication network. Additionally, skilled persons will appreciate that an element of system 100 may communicate with another element through alternative communication networks to network 118. For example, in some embodiments, financial institution 104 may be locally connected to user workstation 102, while also connected for communication with financial transaction network 114 through a wide area network or the Internet. Additionally, network 118 as shown includes gateway 124, that routes the traffic from one of the elements in system 100, for example financial institution 104, to another element in system 100, for example user workstation 102. IN some embodiments, gateway 124 can additionally act as a proxy server and a firewall. Skilled persons will appreciate that in some embodiments, gateway 124 may be an element of financial institution 104, financial transaction network 114 or third party financial institution 116. Also, in some embodiments, each of financial institution 104, financial transaction network 114 or third party financial institution 116 can have its own gateway. In some embodiments, elements of networks 114 and 122 may be controlled by neither financial institutions 104 or 116, and may be operated independently as an intermediate entity that provides and/or facilitates secured and trusted communications, operations and transactions, between financial institutions 104 and 106, as described in more detail below.

In the embodiment shown, financial institution 104 has new account module 108 which can implement methods to open new financial accounts for users, such as users who do not already have an account with financial institution 104. Module 108 can store profiles of users opening, or attempting to open, new accounts in user profiles database 110. For accounts that are opened by new account module 108, such new accounts are stored in accounts database 112, which can include information such as account number, name of account holder and the funds available in the account. In some embodiments, elements of financial institution 104 shown in FIG. 1 may also be operated from within an account generation server. It will be appreciated that the term server may refer to single or multiple computer processors, with access to centralized or distribute computing resources, processors, memory and computer readable storage media.

Additionally, financial institution 104 has user evaluation module 120 which can evaluate a user trying to open a new account and provide results representative of the confidence that the user opening the account should be permitted to open the new account. For example, user evaluation module 120 can provide results representative of the confidence that the user is the individual who they are claiming to be during an account opening process.

User workstation 102, can be used by a user who wishes to open a new account with financial institution 104. In such situations, methods are performed by user evaluation module 120 to assess, among other things, whether the user is the person who they claim to be or whether they are, for example, a fraudster (for example, a user attempting to defraud the financial institution) or making an unapprovable attempt to create an account. In the embodiments, an attempt to create an account may be judged to be carry too high a risk of fraudulent activity that it cannot be approved, such as for example, if certain confidence criterion (or score) are not deemed to be over particular predetermined or dynamic thresholds. Additionally new account module 108 can operate to complete an account opening process by opening and verifying the new account by a fund transfer.

For example, in the embodiment shown, a user operating user workstation 102 can have their identity verified by user evaluation module 120, which is in communication with user verification network 122. In some embodiments, based on information provided by the user, such as personal information including the user's name (including their first name and last name), their current address and their date of birth or the prefix or suffix of the user's name, the user's middle name, telephone number, email address, social insurance number, social security number, previous address(es), employer/previous employer name and address, and/or driver's license number, a user profile is generated and stored in user profiles database 110. Additionally, other information associated with user workstation 102 can be obtained, such as user workstation's 102 Internet Protocol (IP) address and/or Media Access Control (MAC) address of user workstation 102, and other hardware or software attributes of workstation 102 can be collected and stored in user profiles database 110. User evaluation module 120 of financial institution 104 can generate a confidence score based on the user profile where the confidence score can be representative of the likelihood that the information submitted in respect of the user may be for a fraudster, or an unapprovable request for an account.

User evaluation module 120 can determine a first user confidence score based on geographical information provided by the user, such as their address, and based on other information retrieved from user workstation 102, such as user workstation 102 IP address or MAC addresses of user workstation 102 hardware. This information can be compared to data that is internal to financial institution 104, such as lists of known fraudsters or locations or jurisdictions, or geographic areas with a high risk of fraud and can be provided to user verification network 122 which can provide further evaluations of risk of fraudulent activity based on this geographic data resulting in a confidence score. The score may be lower where the geographic data is associated with higher risks of fraudulent activity. In some embodiments user evaluation module 120 can track the IP addresses of users who attempt to open accounts and if the same IP address has attempted to open an account within a predetermined time period, a low confidence score can be generated.

User evaluation module 120 can determine a second user confidence score based on the identity of the user trying to open a new account, by determining if there are any inconsistencies with known information about the user and the information provided by the user in the account opening request or attempt. For example, user evaluation module 120 can access information available in user verification network 122 to determine if the user has a minimum credit history, such as 6 months of credit history, and/or whether the address and/or phone number provided by the user is consistent with the address information and/or phone number available for this user in user verification network. Based on any consistencies or inconsistencies, the second user confidence score can be generated which can be representative of the confidence in whether the user opening the account is the individual who they are claiming to be.

Further, user evaluation module 120 can determine a third user confidence score based on additional information about the user from user verification network 122 which can include third party credit assessment providers, other financial institutions, and other information repositories that are publicly available or available by subscription. User evaluation module 120 can use this information to generate a series of questions that can be provided to a user through user workstation 102. The questions can have answers that the user would typically know if the user is the individual who they are claiming to be. A third confidence score can be generated based on the accuracy of the answers provided by the user. This third confidence score can be representative of the likelihood that the user opening an account financial institution 104 with user workstation 102 is the individual who they are claiming to be.

Based on the confidence scores determined by user evaluation module 120 an overall user confidence score is generated, which, in some embodiments can be a weighted average of the previously determined confidence scores. If the calculated overall user confidence score is higher than a pre-determined threshold value, then the user may be verified.

Once the user using user workstation 102 has been verified by user evaluation module 120, new account module 108 can complete the account opening process by initiating a transfer of funds from a third party financial institution 116 that the user has an existing account, to financial institution 104. In the embodiments shown, financial transaction network 114 operates to initiate and facilitate the transfer the funds from third party financial institution 116 to financial institution 104 through network 118. A user using user workstation 102 can log on to their account with third party financial institution 116, either directly with third party financial institution 116, through gateway 124 or through an interface provided by financial transaction network 114 that can direct funds to be transferred from third party financial institution 116 through financial transaction network 114 to financial institution 104, in various embodiments as described in more detail below.

Once the transfer of funds from third party financial institution 116 to financial institution 104 is verified, a new account is created by new account module 108 and the new account information is stored in accounts database 112 of financial institution 104. Funds can be transferred from third party financial institution 116 immediately on verification of the fund transfer, or, in some embodiments, financial institution 104 may not receive funds until all new accounts opened in a predetermined time period, such as a business day, are reconciled. Such reconciliation of accounts may be provided by financial transaction network 114, which can keep records of all new account openings and all funds approved and verified for transfer, and can provide the necessary funds, for example at the end of each business day, to financial institution 104 to reconcile the new account openings for that business day.

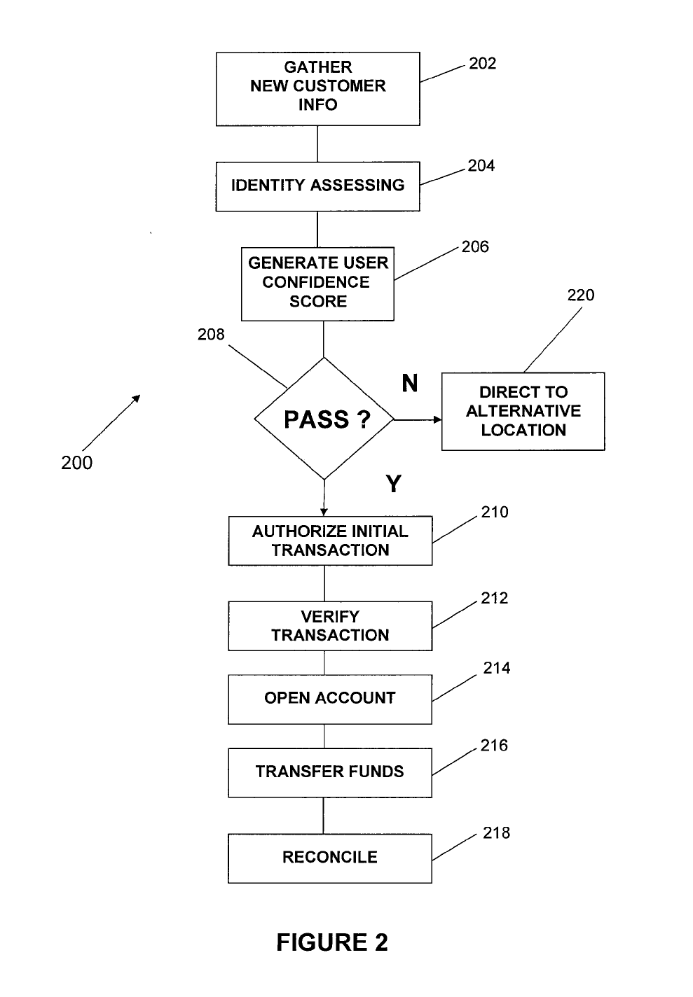

Referring to FIG. 2, method 200 for creating an account with a financial institution for a user. At 202, new customer information is requested and retrieved from a user using user workstation 102. In some embodiments, financial institution 104 can have a server or processor with application software for opening new accounts that may be provided to a local user workstation 102, for example, at a physical branch of financial institution 104, and in other embodiments user workstation 102 can be located at a remote location, such as at a personal computer at a user's home or a mobile device of the user connected to network 118.

Information is obtained from the user at 202 to generate a user profile which can be stored locally on the user's workstation and/or in user profile database 110 of financial institution 104. Locally stored information at workstation 102 may be kept in a secured or encrypted format by the application communication with financial institution 104. In embodiments where the user profile is stored locally, user workstation 102 typically will provide financial institution 104 with access to the user profile. In some embodiments, financial institution 104 can keep this information for an extended period of time even after the user has opened a new account or in cases where the user fails to open a new account. In some embodiments, after obtaining the consent of the user for a variety of reasons discussed below, information relating to the user and a failed attempt can tend to assist financial institution 104 in improvements to system 100 and in implementing method 200. For example, such information may tend to be helpful in developing improved fraud detection systems, improving the reliability of confidence scoring, or helping in providing directed marketing to customers regarding accounts or other financial vehicles customers may be interested in.

The information obtained from the user at 202 can include the user's name (including their first name and last name), their current address and their date of birth, occupation, employer and/or income. In some embodiments, other information, such as the prefix or suffix of the user's name, the user's middle name, telephone number, email address, social insurance number, and/or driver's license number may also be obtained.

Once a user profile is generated based on information obtained from a user at 202, the identity of the user can be validated, which assessment can be used to generate a confidence score regarding the user who is attempting to open an account. The assessment and score will tend to be representative of the confidence the assessment has in that the user is indeed who he or she claims to be, and is not a fraudster.

At 204, user evaluation module 120 of financial institution 104, using the user profile generated at 202, generates confidence scores representative of the confidence of financial institution 102 that the user who is opening an account is the individual who they claim to be. In some embodiments, confidence scores generated at 204 may additionally be representative of a user's money laundering risks and possible terrorist funding activities risks. In some embodiments, these confidence scores can be based on data retrieved from third party sources, such as databases that include known fraudsters. In other embodiments confidence scores can additionally or alternatively be based on data internal to financial institution 104, for example, databases that include the IP address of users previously assessed as a fraudster or associated with a high risk of fraudulent activity by financial institution 104. In other embodiments, confidence scores can be generated in real time, by requesting information from the user that financial institution 104 already knows about the user and assessing the confidence that the user is the individual is who they say claim to be based on whether the information provided by the user matches the information about that user previously known by the financial institution. At 206, an overall user confidence score is determined based on the confidence scores generated at 204. In some embodiments the overall user confidence score can be a weighted average of the confidence scores generated at 204.

At 208, method 200 evaluates the overall confidence score of the user and if the overall confidence score is less than a pre-determined threshold value the process is ceased and the user is directed to an alternative location at 220, such as a physical branch of financial institution 104. In other embodiments, error messages can be provided to the user, the process may quit without informing the user, or any other similar stoppage to the process may occur at 220.

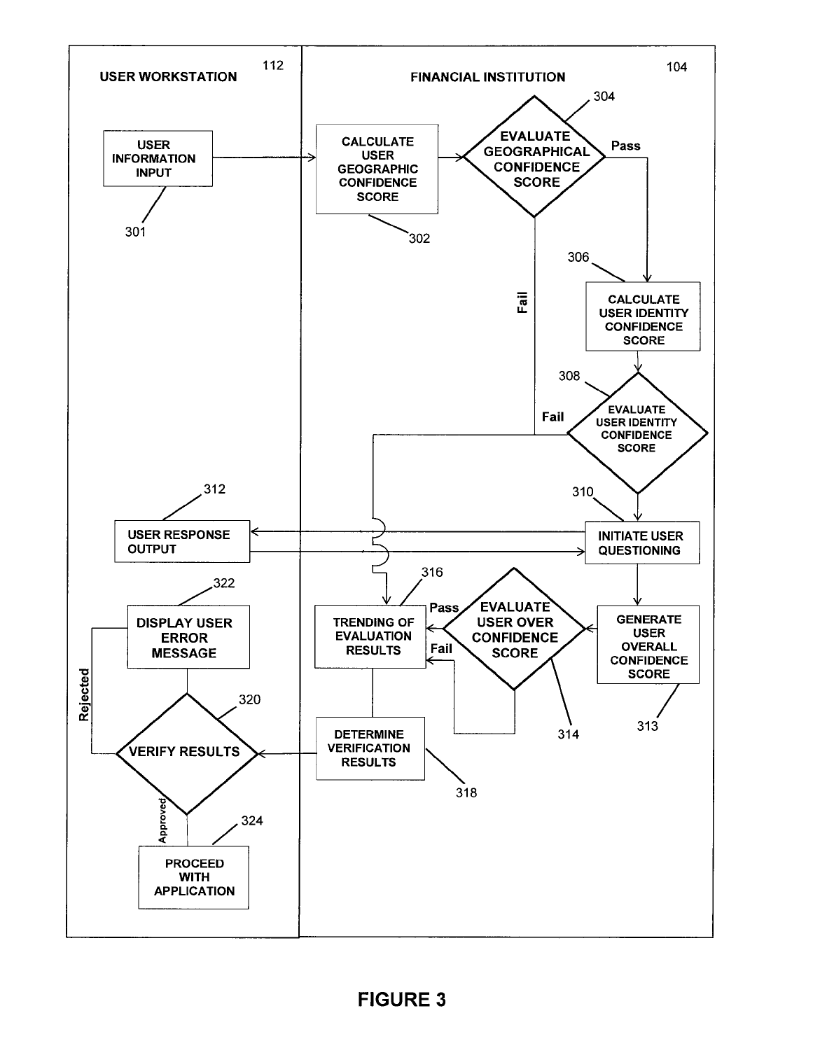

With additional reference to FIG. 3, an exemplary process is shown where user evaluation module 120 of financial institution 104, using the user profile generated at 202, generates confidence scores representative of the confidence of financial institution 102 at 204, determines an overall confidence score at 206 and evaluates the overall confidence score at 208. In the embodiment shown, the process steps of financial institution 104 shown in FIG. 3 are also carried out by user evaluation module 120.

At 301, a user at user workstation 102 provides information to financial institution 104, which can include their first name and last name, current address, date of birth, prefix or suffix of the user's name, middle name, telephone number, email address, social insurance number, and/or driver's license number. At 302, geographic IP validation is conducted which, in some embodiments, can include evaluating geographic information provided by the user at 301 and can additionally include obtaining information from the workstation being operated by the user, such as, the IP address or the MAC addresses of any hardware or other equipment being used by the user as they interact with financial institution 104 to open a new account. In some embodiments, this information can be added to the user profile created at 202.

At 302, this geographic information is evaluated and a first confidence score or a geographic confidence score is generated, based on the information gathered. For example, the IP address of the user workstation can be compared to known IP addresses of fraudsters, generating a high confidence score if the IP address is not associated with known fraudsters. In other embodiments, the IP address can be compared with a log file of IP addresses that have interacted with financial institution 104 to open a new account in the past, such as IP addresses of user workstations which have repeatedly tried to open, and failed to open, a new account. In such embodiments, if the same IP address has been used multiple times or by multiple users that day to open accounts, each resulting in a failed attempt to open an account, or if the same IP address has been used by a user to open multiple accounts over a longer period of time, perhaps with some successful attempts and some failed attempts, this may result in a low confidence score, tending to indicate that the IP address of the user may be conducting fraudulent activity. In other embodiments, if the geographic information provided by the user is not consistent with the user's known address, or if it is located in a country that has been deemed to be high risk (for example, due to high incidence of fraud), this can generate a low confidence score.

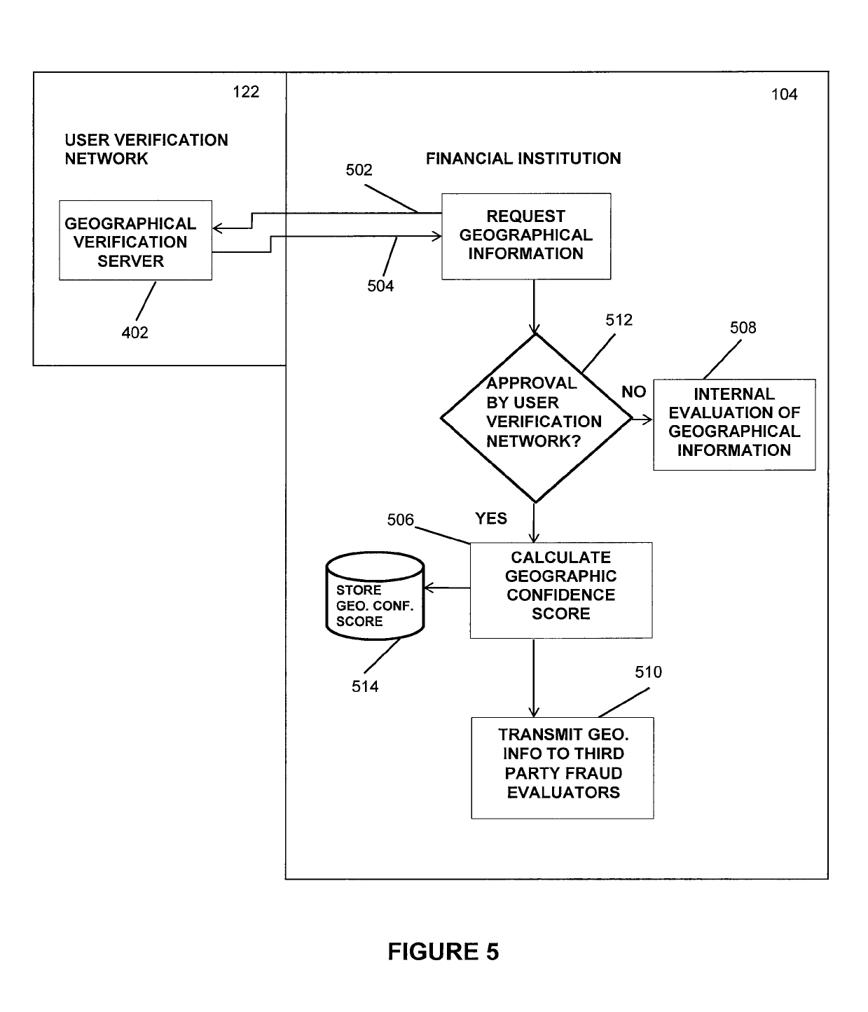

With additional reference to FIG. 5 an alternative process is shown for generating a geographic confidence score at 302 based on the geographic information obtained from a user at 301, either from the user profile information provided by the user or the user workstation information (such as the IP address of the user workstation) or both, can be provided to user verification network 112 which can provide geographic verification module 402, which in some embodiments may be a third party external fraud evaluation system, which can provide an evaluation and confidence score of the user to the financial institution 104. For example, at 502, geographic information is provided to geographic verification module 402 and at 504, results are provided back to financial institution 104, where such results can include a user verification report from geographical verification module 402 (which may include a pass or fail assessment, or a confidence score assessment, of the user to financial institution 104).

At 512, financial institution 104 reviews and/or evaluate (in some embodiments the review and evaluation being automated) the report provided by geographical verification module 402 and if geographical verification module 402 provided a negative assessment with respect to the user, at 508 financial institution 104 can additionally evaluate the geographic information, as well as any additional data provided to financial institution 104 by geographic verification module 402 before calculating a geographic confidence score at 506. If the user received a positive assessment of the user at 512, a first or geographic confidence score for the user is generated at 506, which may not include any evaluation of additional data by financial institution 104.

At 514 the results of calculating the first geographic confidence score and/or any additional information or reports received from geographic verification module 402 can be stored in a geographic confidence score database. The results are evaluated, and if a third party system is used and returned a favorable result, the result can be evaluated by the financial institution 104 at 506. If the result was unfavorable, the financial institution can conduct additional evaluation at 508, which can further evaluate the geographic confidence in the user.

At 510, additional third party fraud evaluation providers are provided with the geographic information which can provide financial institution 104 with additional data regarding fraud risks of the user for adjusting or recalculating the geographical confidence score; however, additional evaluation by other fraud evaluation systems may optionally be used. For example, some other fraud evaluation systems can additionally be utilized to provide information regarding the location of the address of the user, for example, such as whether the user is providing information to financial institution 104 from a prison, airport or multi-person dwelling. Additionally, such systems may be used to assess the telephone number of the user and determine whether that telephone number has been previously linked to other fraudulent activities or is an answering service. Additionally, in other embodiments, fraud evaluation systems may also be used to determine whether the IP address and/or name have been previously associated with a different user. In some embodiments, these evaluations can be performed by geographical verification module 402, or can be performed by financial institution 104 at 508 in other embodiments.

Referring back to FIG. 3, at 304 if the first confidence score generated at 302 is lower than a pre-determined threshold value, the identity assessment fails and the failure is logged by financial institution 104 and may be stored in a database by financial institution 104 for future use in fraud detection. For example, by logging an IP address that is determined to have a low confidence score, future attempts by that IP address (or addresses proximate to that IP address) to open a new account may be given a lower confidence score, and thus tending to improve security. In some embodiments, if a user having the same IP address applies for a new account multiple times in a predetermined time period (such as three or more times), such as in one hour, the user's information can be logged by financial institution 104. In other embodiments, financial institution 104 can communicate any fraudulent activities detected to the authorities, who can take further action if necessary.

At 304, if the confidence score generated at 302 is higher than a pre-determined threshold value, at 306 a second or user identity confidence, score is generated. In some embodiments, credit bureaus can be provided with the user information provided at 301 and the user identity confidence score can be determined based on whether the user has a minimum credit history, for example, 6 months of credit history, whether the address provided by the user at 301 is consistent with the same user's address on record at the credit bureau (and additionally, it may be confirmed whether the date of birth, phone number, social insurance number, postal code, or other personal information provided by the user at 301 is consistent with the records of the credit bureau).

At 308, if the user identity confidence score generated at 306 is lower than a pre-determined threshold value, the identity assessment fails and the failure is logged by the financial institution and may be used by the financial institution for fraud detection in the future, as described above.

At 308, if the confidence score generated at 306 higher than a pre-determined threshold value, at 310, questions are provided to the user, and answers are retrieved from the user at 312. The questions provided at 310 would tend to request answers that the user would know only if they are the individual who they are claiming to be. In some embodiments, the information used to generate the questions can be obtained from third party sources, for example, credit history resources, and the information obtained from such third party sources can be parsed by the financial institution to generate these questions. For example, questions to the user may include: (1) provide a previous address; (2) provide your cellular phone provider; (3) do you have a personal or home line of credit and if so, with which financial institution; (4) provide the names of credit card companies you have credit cards with; (5) which year did you establish your most recent car loan. Skilled persons will appreciate that the list of example questions described is not an exhaustive list. Additionally in some embodiments, the questions may be in multiple choice form, providing four or more answers to select from and in other embodiments blank text fields may be provided for the user to provide the answer. Based on the answers provided by the user, a third confidence score is generated at 311 representative of the confidence that the user is the individual they claim to be.

At 313, an overall user confidence score is generated based on the confidence scores generated at 302, 306 and 311, which can be a weighted average of the previously generated confidence scores. In some embodiments, each confidence score can be evaluated and a weighting can be applied to indicate the degree of associated risk for that confidence score. In some embodiments the weightings can be adjusted dynamically by financial institution 104 in real-time (or near real-time) to provide the ability to respond to new fraud risks as soon as they are identified.

The overall confidence score generated at 313 is evaluated at 314. If the confidence score generated is higher than a pre-determined threshold value, the user's identify receives a pass and the user's identity is verified. If the confidence score generated is lower than the pre-determined threshold value, the user is rejected and information is logged to a data file of the financial institution which may tend to be useful for future identity proofing by the financial institution, as described above.

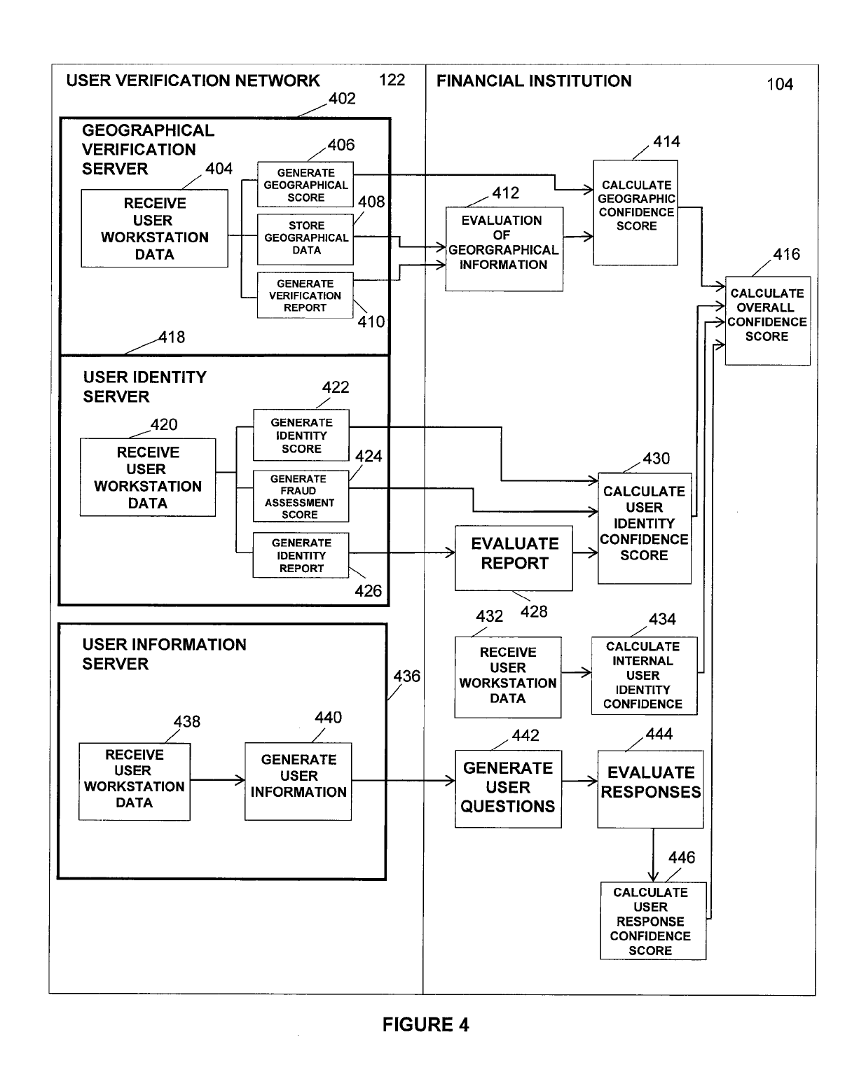

With reference to FIG. 4, an alternative process is shown where user evaluation module 120 of financial institution 104, using the user profile generated at 202, generates confidence scores representative of the confidence of financial institution 102 at 204 and determines an overall confidence score at 206. In the embodiment shown, financial institution 104 communicates with user verification network 122 to generate an overall confidence score that is representative of the confidence financial institution 104 has that the user is the individual who they are claiming to be when opening a new account with financial institution 104. In the embodiment shown, user verification network 122 comprises geographical verification module 402, user identity module 418 and user information module 436, each of which can be a module operated by an independent third party or systems; however in other embodiments, user verification network 122 can be part of financial institution 104.

At 404, geographic verification module 402 receives user information that was provided by a user at user workstation 102. The user information, in some embodiments, can be provided to financial institution 104 and communicated to geographic verification module 402 by financial institution 104 and in other embodiments, the user information can be communicated directly from user workstation 102 to geographic verification module 402. As described above, the user information can consist of the user's name (including their first name and last name), their current address and their date of birth or the prefix or suffix of the user's name, the user's middle name, telephone number, email address, social insurance number, social security number, previous address(es), employer/previous employer name and address, and/or driver's license number and, in embodiments where financial institution 104 transmits the user information to geographical verification module 402, the information can be retrieved from user profile database 110.

At 406, geographic verification module 402 generates a geographic confidence score that can be representative of the risk that the user using user workstation 102 is not the individual who they are claiming to be, or that they are a located in a jurisdiction or physical location that is known to be or is likely to be operated by a fraudster. For example, the geographic confidence score can be generated based on whether the IP address of the user workstation is listed on known IP addresses of fraudsters. In other embodiments, the IP address of user workstation 102 can be compared against log files accessible by geographic verification module 402 to determine whether the IP address of user workstation 102 is an IP address that has attempted to create multiple new accounts during a recent time period (for example if the same IP address has attempted to open 3 or more accounts in the last hour, this can be representative of a potential fraudster using user workstation 102). Additionally, in other embodiments, the user information provided by the user can be analyzed by geographic verification module 402, for example, by reviewing the address provided by the user using user workstation 102 and the generated geographic score can be based on whether the user is located in a geographic location that is deemed to be high risk (for example due to a high instance of fraud in a known region or country).

At 408, geographic data received at 404 is stored by geographic verification module 402 and at 410, geographic verification module 402 generates a verification report. Each of the stored data and verification report are transmitted to financial institution 104. In some embodiments, user evaluation module 120 of financial institution 104 can generate an interim geographic verification score at 412 based on the geographic information and report provided by geographic verification module 402. In some embodiments, financial institution 104 may not independently evaluate the geographic information and report generated at 408 and 410, respectively.

At 414, financial institution 104 receives the geographic verification score determined at 406 by geographic verification module 402 as well as the interim geographic verification score generated at 412 and determines a user geographic confidence score representative of the fraud risk of the user based on their location or geographic data. In embodiments where financial institution 104 does not generate an interim geographic verification score, the user geographic confidence score can be generated based on the geographic verification score determined at 406 by geographic verification module 402.

At 420, user identity module 418 receives user information that was input by a user at user workstation 102. The user information, in some embodiments, can be provided to financial institution 102 and communicated to user identity module 418 by financial institution 102 and in other embodiments, the user information can be communicated directly from user workstation 102 to user identity module 418. As discussed above, the user information can consist of the user's name (including their first name and last name), their current address and their date of birth or the prefix or suffix of the user's name, the user's middle name, telephone number, email address, social insurance number, and/or driver's license number and, in embodiments where financial institution 104 transmits the user information to user identity module 418, the information can be retrieved from user profile database 110.

In some embodiments, user identity module 418 can be administered by a credit bureau and at 422 can generate an identity confidence score that can be determined based on whether the user has a minimum credit history, for example, 6 months of credit history, whether the address provided by the user at 301 is consistent with the same user's address on record at the credit bureau (and additionally whether the date of birth, phone number, social insurance number, postal code, or other personal information provided by the user at 301 is consistent with the records of the credit bureau).

At 424, a fraud assessment score can be generated by user identity module 418 using user information received at 420 and can be determined by comparing the user information to lists or databases of known fraudsters. For example, by reviewing lists of databases of known fraudsters and determining if the user name, address, social insurance card number and/or driver's license number provided by the user is a known fraudster. In some embodiments, the fraud assessment source can be generated by 424 by looking for indicators or potential fraud. In some embodiments, these indicators can include factors, or alert flags, such as the user trying to open a new account is known to be deceased, the user trying to open a new account is using a user ID that has previously been reported as lost or stolen, the address or telephone number provided by the user has been reported as being involved in a criminal activity or the address or telephone number provided by the user being associated with an institution (such as a hospital), a commercial property, an airport or a prison.

At 426, user identity module 418 generates an identity report for the user, which can be transmitted to financial institution 104 for evaluation at 428. The identity report for the user provides details regarding the fraud indicators identified at 424.

The user identity score determined at 422 and the fraud assessment score determined at 424 are provided to financial institution 104 and at 430, financial institution 104 determines a user identity confidence score, and in some embodiments the user identity confidence score is additional determined based on the report evaluation at 428. In some embodiments, the user identity confidence score determined at 420 is determined by user evaluation module 120.

In some embodiments, at 432, financial institution 104 retrieves user workstation data, for example, from user profiles database 110, and, at 434, can determine an internal user identity confidence score, which can be determined based on the user information provided by user at user workstation 102 as well as historical data previously known by financial institution 104. In some embodiments, this historical data can include IP addresses previously known as fraudster IP addresses by financial institution 104 or information about individuals previously known as fraudsters by financial institution 104.

At 438, user information module 436, which can be administered by a credit bureau or other information provider, receives user information that was input by a user at user workstation 102. The user information, in some embodiments, can be provided to financial institution 104 and communicated to user information module 436 by financial institution 104 and in other embodiments, the user information can be communicated directly from user workstation 102 to user information module 436. As discussed above, the user information can consist of the user's name (including their first name and last name), their current address and their date of birth or the prefix or suffix of the user's name, the user's middle name, telephone number, email address, social insurance number, and/or driver's license number and, in embodiments where financial institution 104 transmits the user information to user information module 436, the information can be retrieved from user profile database 110.

At 440, user information module 436 obtains additional user information based on the user information retrieved at 438. For example, in some embodiments, credit histories of the user are retrieved that may include information such as mortgages, car loans, credit card purchase and payment histories, accounts at third party financial institution 116's, or other financial information that may be available to user information module 436 from the institution administering user information module 436.

At 442, the user information generated at 440 is transmitted to financial institution 104 and questions are generated to be provided to a user at user workstation 102 based on the information received from user information module 436. The answers to the questions generated will be answers that the user would tend to know only if they are the individual who they are claiming to be. For example, questions poised to the user may include: (1) provide a previous address; (2) provide your cellular phone provider; (3) do you have a personal or home line of credit and if so, with which financial institution; (4) provide the names of credit card companies you have credit cards with; (5) which year did you establish your most recent car loan. It will be appreciated that the list of example questions described is not an exhaustive list. Additionally in some embodiments, the questions may be in multiple choice form, providing four or more answers to select from and in other embodiments blank text fields may be provided for the user to provide the answer. At 444, the user's responses are analyzed and based on the user's answers to the questions, a user response confidence score is generated at 446.

At 416, each of the confidence scores generated at 414, 430, 434 and 446 are evaluated to generate an overall user confidence score, which, in some embodiments, can be a weighted average of the previously determined confidence scores. For example, the confidence scores generated at 414, 430, 434 and 446 can be normalized to enable comparison of values. In some embodiments, each confidence score can be evaluated and a weighting can be applied to indicate the degree of associated risk. In some embodiments, different weightings can be applied not only to the individual components, but also the type of customers and products for which they are applying, to determine a risk relative to the application being evaluated. The weightings can be adjusted by financial institution 104 in real-time (or near real-time) to provide the ability to quickly respond to new fraud risks, as soon as a risk has been identified. In some embodiments, the overall confidence score generated at 416 can be dynamically adjusted if one of the geographic verification module 402, user identity module 418 or user information module 436 is unavailable. Skilled persons will additionally understand that user verification network 122 can comprise one or more geographic verification module 402, user identity module 418 or user information module 436, which can each provide a confidence score to financial institution 104 for calculating the overall confidence score at 416.

Referring back to FIG. 2, if the overall confidence score of the user is determined to be greater than a pre-determined threshold value, then at 210 the user is requested to authorize a transaction with third party financial institution 116 to transfer an amount of funds to the financial institution the user is opening a new account with as a further verification of the user to financial institution 104. In some embodiments, the user can be provided with a unique identifier by financial institution 104, such as for example, a unique account number, which may be a temporary account number until the new account is validated by completion of a transaction. In such embodiments, the unique identifier may be stored in accounts database 112 and may be linked to the user profile stored in user profiles database 110.

In some embodiments, the user can be provided with a prompt by financial institution 104 requesting information about third party financial institution 116 that the user has an account with as well as a dollar amount to be transferred. In some embodiments, the dollar amount may be set by financial institution 104, for example, $1.00, which can tend to limit the financial institution's exposure in the event that the user is a fraudster. In other embodiments, the dollar amount entered by the user can be limited by third party financial institution 116, due to, for example, internal policies of third party financial institution 116 that may limit the amount of funds an account holder is permitted to transfer to a different financial institution.

In some embodiments, the user can identify their account with third party financial institution 116 using Magnetic Ink Character Recognition (MICR) information, which can represent unique information associated with their account at third party financial institution 116. MICR information can include a bank number, a transit number and an account number, indicating the account at third party financial institution 116 the user wishes to transfer funds from. Additionally, in some embodiments the MICR information can be used to verify that the account at third party financial institution 116 is a personal account and not, for example, a business account, foreign currency account or credit product.

In some embodiments, prior to initiating a financial transaction with third party financial institution 116, but after receiving the information identifying the third party institution, third party financial institution 116 account information provided by the user can be verified to determine whether third party financial institution 116 is an existing and known financial institution and/or if they have the capabilities to transfer funds electronically to the financial institution 104. For example, some financial institutions may be members of a financial transaction network which allow electronic fund transfers between financial institutions who are members of the same network. In such embodiments, third party financial institution 116 information can be verified to determine if they are members of the same financial transaction network as the financial institution the user is opening a new account with, and once this has been verified, the transaction can proceed as requested by the user. In some embodiments, this verification can be performed by the financial institution where the new account opening is being conducted, and in other embodiments, this verification can be conducted by a third party, such as a financial transaction network provider.

In some embodiments, third party financial institution 116 can include credit institutions or wealth management and fund institutions, such as mutual funds and or other investment accounts. In other embodiments, third party financial institution 116 can in include other commercial entities where the user is known and has an existing account and has authorized the user to complete financial transactions with third parties.

At 212, the transaction with third party financial institution 116 that was initialized and initiated by the user at 210 is verified. In some embodiments, for example those embodiments where funds are transferred through a financial transaction network, the verification can be provided by the financial transaction network provider, and in other embodiments, the verification can be provided directly by third party financial institution 116 to the financial institution 104. The verification at 212 can include providing information to the financial institution where the new account is being opened related to the existence of the account with the third party institution, the confirmation that the user who initiated the transaction is the owner or a person authorized to withdraw and/or transfer money from the account, and can additionally include information confirming that there are sufficient funds in third party financial institution 116 account to complete the transfer.

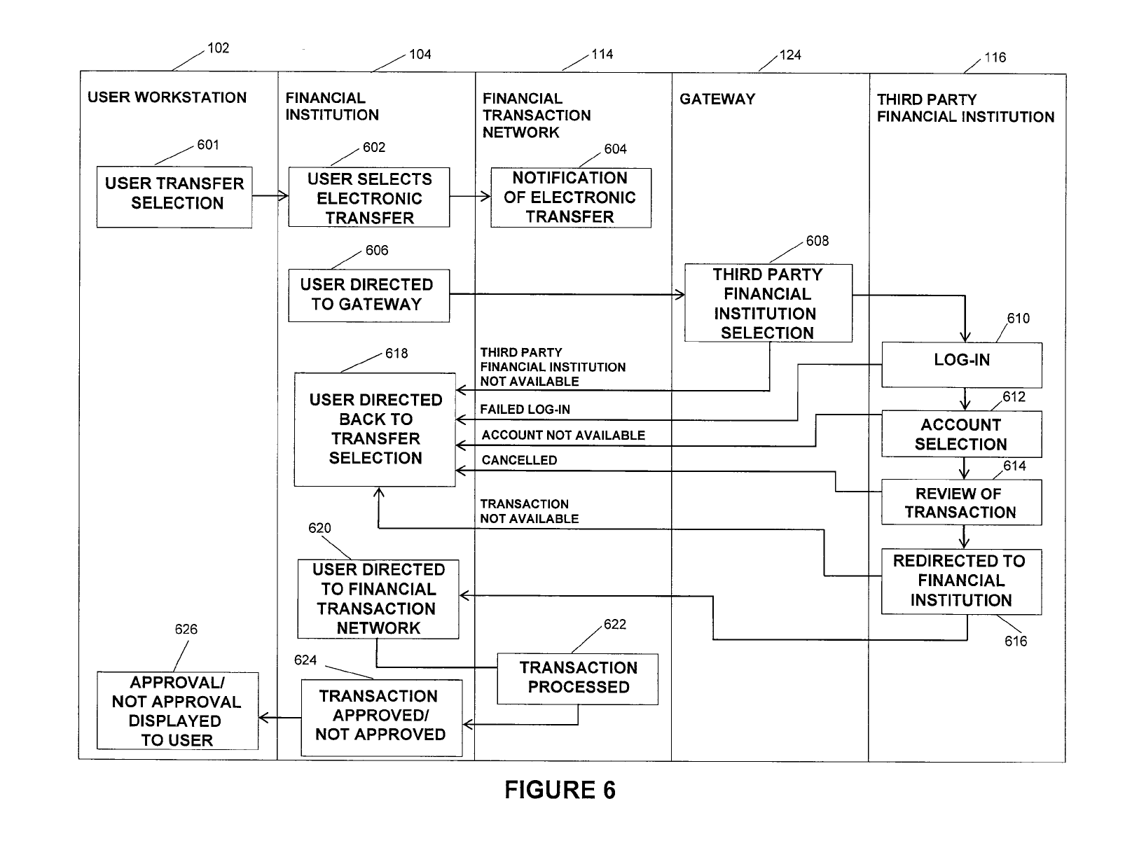

With additional reference to FIG. 6, there is a further embodiment of a process flow that is managed and/or initiated by new account module 108 for authorizing, initiating, conducing and verifying a transaction with financial institution 104, for implementing 212 of FIG. 2 in an exemplary embodiment. In the embodiment shown in FIG. 6, a user using user workstation 102 interacts with financial institution 104 at 601 to select the type of fund transfer and at 602, user workstation 102 indicates to financial institution 104 that the account opening and verification procedure will be completed by the electronic transfer of funds from third party financial institution 116. At 604, financial transaction network 114 is alerted that the user will be initiating an electronic transfer of funds from third party financial institution 116 and financial transaction network 114 transmits a redirect message at 604 to financial institution 104. Financial institution 104 directs user workstation 102 to third party financial institution 116 at 606. In some embodiments, financial transaction network 114 does not need to be notified, and in such embodiments, financial institution 104 may redirect user workstation 102 to third party financial institution 116 when a user using user workstation 102 selects the account opening and verification procedure will be completed by electronic transfer of funds from third party financial institution 116. In some embodiments, third party financial institution 116 is located in the same country or jurisdiction as financial institution 104.

At 606, financial institution 104 directs the user at user workstation 102 to third party financial institution 116 through gateway 124. In some embodiments, this can be done by way of a user interface provided by financial institution 104, such as a website, to transfer the user at user workstation 102 to the user interface of third party financial institution 116, for example, the website of third party financial institution 116. In some embodiments, gateway 124 can provide a list of third party financial institutions that are authorized to conduct electronic fund transfers with financial institution 104. For example, in embodiments where financial institution 104 a member of financial transaction network 114, this list can include all other financial institutions that are members of the same network.

In the embodiment shown, if third party financial institution 116 is unavailable or unauthorized to electronically transfer funds to financial institution 104, user using workstation 102 may not be able to open and verify the account by electronic transaction and alternative options may be presented to the user, for example, directing the user to the physical financial institution offices or branches in order to complete the account opening and verification process.

If third party financial institution 116 is authorized to electronically transfer funds to financial institution 104, user workstation 102 is directed by gateway 124 to third party financial institution 116 at 608. At 610, the user using user workstation 102 is directed to log-on to their online bank account with third party financial institution 116. In some embodiments, where user workstation 102 is interfacing with financial institution 104 through the Internet, such as through the website or online banking portal of financial institution 104, when user workstation 102 is directed to third party financial institution 116, the website or online banking portal of third party financial institution 116 can be accessed directly by the user, and user workstation 102 may provide the user with a display of, for example, a log-on portal screen for third party financial institution 116.

Once logged on, the user using user workstation 102 selects which account they will be transferring funds from at 612 and at 614 the user can review the transaction they have selected with third party financial institution 116 and verify that the information they have provided is accurate. Once the transaction from third party financial institution 116 has been verified and authorized by the user at user workstation 102, the user is redirected back to financial institution 104 at 614.

At any point in the user's interaction with third party financial institution 116, if the user is unable to complete a step, for example, the user fails in the log-on process or user 650 decides not to proceed with the electronic transfer of funds from third party financial institution 116 or the user does not have sufficient funds in their account to complete the transaction, the user at user workstation 102 can be directed back to financial institution 104 and can select and/or be provided with alternative means to open and verify the new account with financial institution 104. For example, the user can physically go to the branch or can mail a cheque linked to an account the user has with third party financial institution 116 to financial institution 104. In some embodiments, reports and/or automated responses can be provided to financial institution 104 outlining the details of the authorized electronic transfer of funds and/or the failed attempts to electronically transfer funds. Such reports can tend to be useful to financial institution 104 for internal auditing purposes and/or to improve fraud detection methods.

Upon successful transfer, at 620, third party financial institution 116 notifies financial institution 104 that the fund transfer is authorized and the transfer is completed by financial transaction network provider 114 at 622. At 624, the user using workstation 102 is notified by financial institution 104 that the electronic transfer of funds from third party financial institution 116 has been completed and the user has been successfully verified by financial institution 104.

In some embodiments, security means can be implemented to detect fraudsters and prevent unauthorized electronic transfer of funds. For example, during the authorization, initiation and verification the electronic transfer of funds, timers can be used which, if expired, can cancel the account opening process. In some embodiments, if the user has not taken any action for 20-45 minutes, the process may be halted. In such embodiments error codes may be logged and stored by financial institution 104.

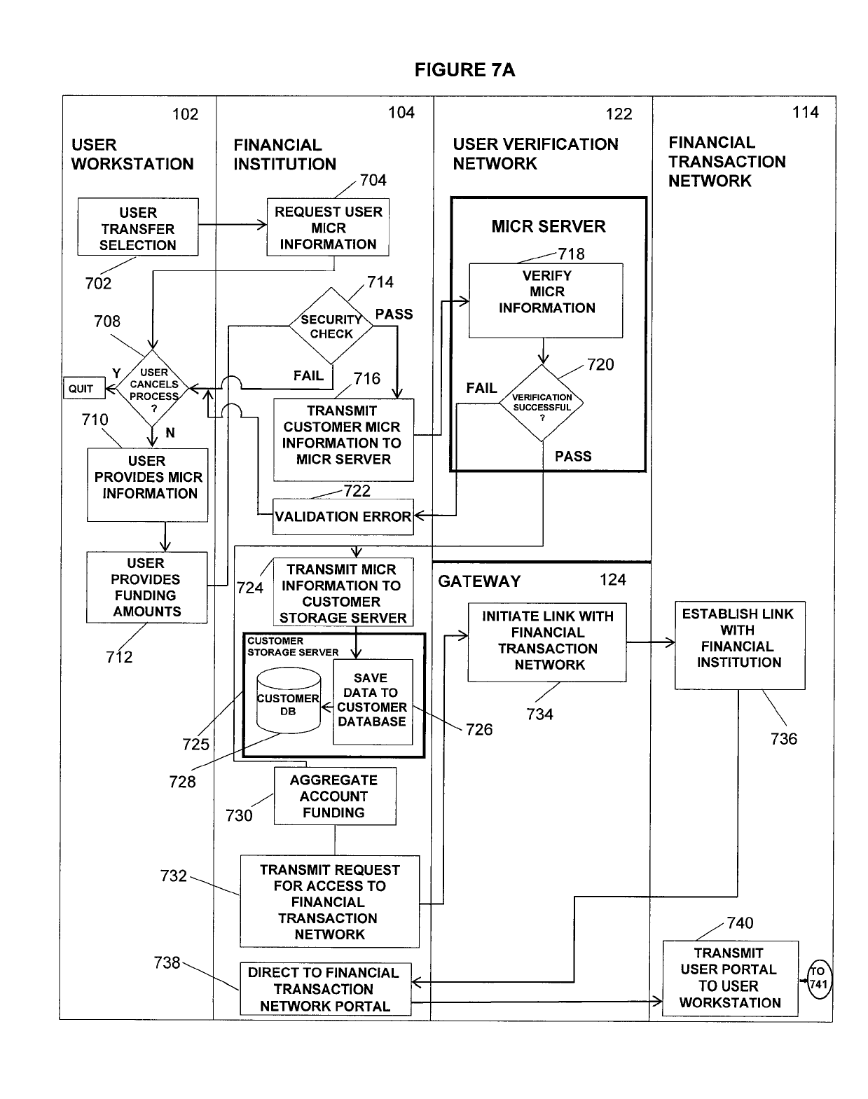

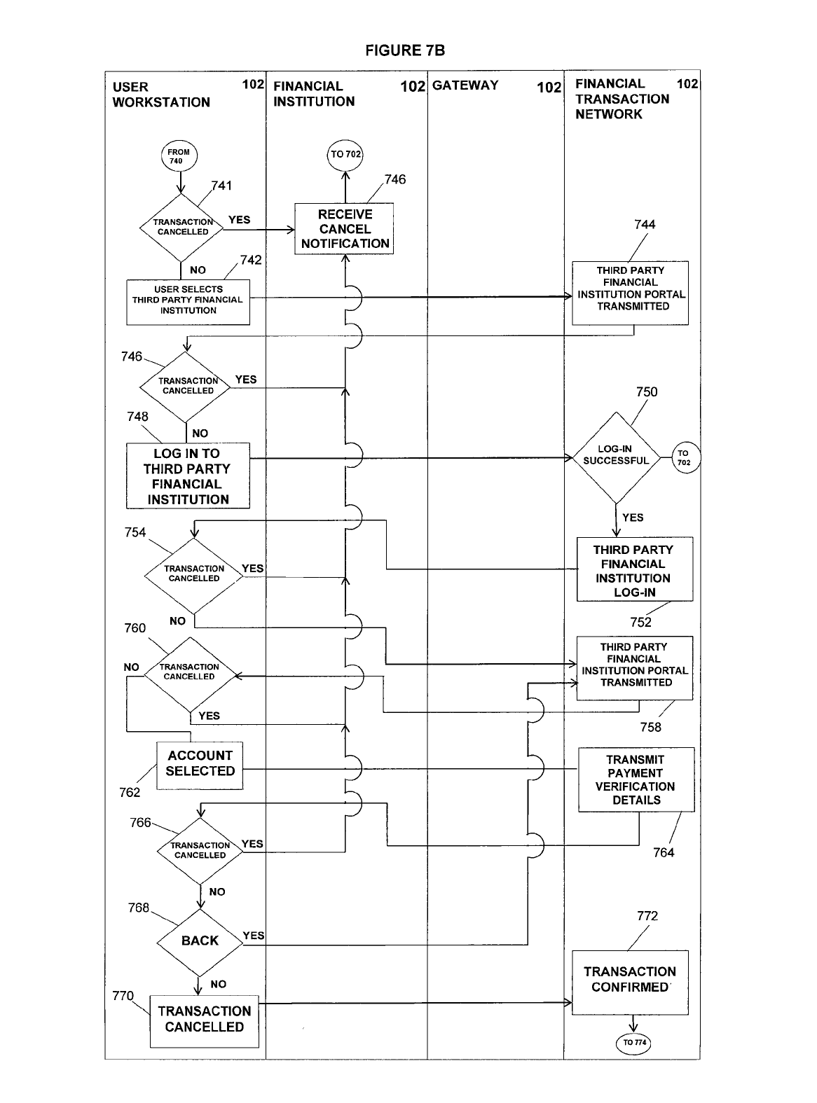

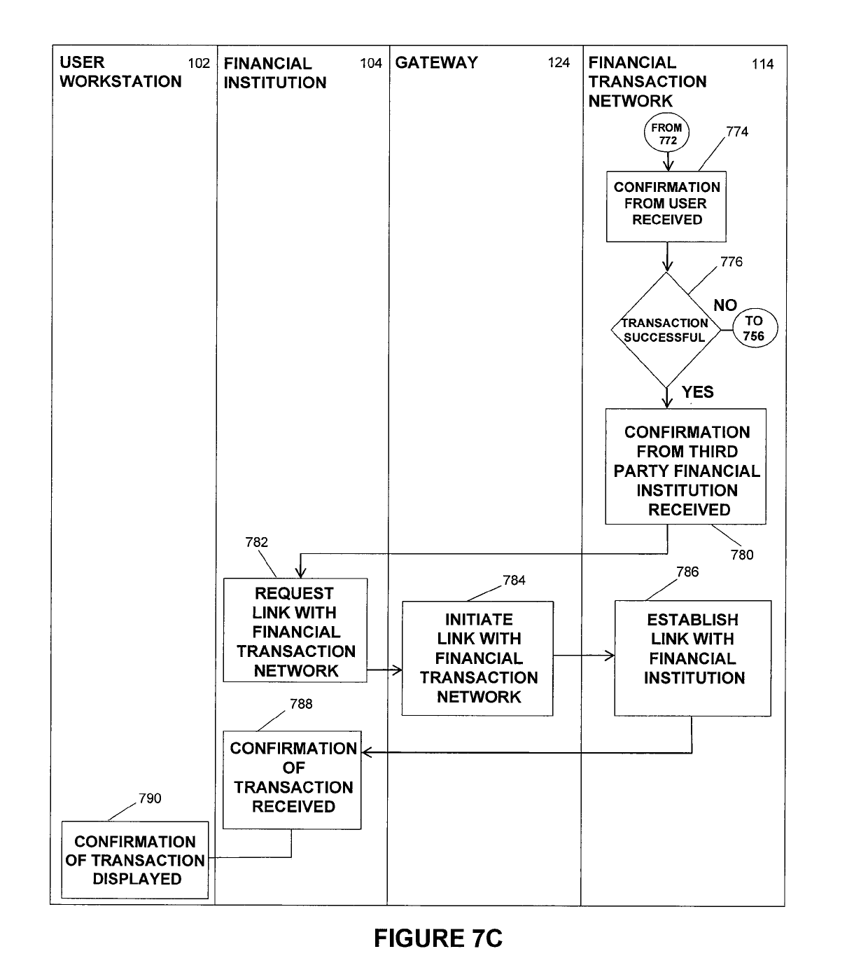

With reference to FIGS. 7A-7C, a process flow that is managed and/or initiated by new account module 108 is shown which is an alternative embodiment of authorizing, initiating, conducting and verifying a transaction with a financial institution for implementing the step of verifying a transaction at 212 of FIG. 2. At 702, user workstation 102 is requested by financial institution 104 to indicate how they will provide the funds required to complete the account opening procedure with financial institution 104 and the user using user workstation 102 selects the method of fund transfer.

If at 702, the user selects that funds will be electronically transferred from third party financial institution 116, user workstation 102 is directed by financial institution 104 to provide information about an account the user has with third party financial institution 116 at 704.

At 708, the user using user workstation 102 selects the cancel option, for example, by pressing a cancel icon or button displayed on user workstation 102, the verification process is cancelled. If the user proceeds with the transfer of funds from third party financial institution 116, at 710 the user using user workstation 102 enters MICR information associated with an account at third party financial institution 116, however, in other embodiments the user can provide any information about an account the user has with third party financial institution 116. In some embodiments, this information can include a bank number, a transit number and an account number. At 712, the user provides the amount of funds they wish to transfer from an account at third party financial institution 116.

At 714, a security check is performed by financial institution 104 to determine if the transfer of funds can proceed. For example, if the user fails to provide all the required information requested at 710 and 712, financial institution 104 can redirect user workstation to 708 and 710 and 712 can be repeated by the user. For example, in some embodiments, if the user does not provide all the accurate information as requested at 710 and 712 on three attempts, the user can be redirected to 708. In some embodiments, an error message can be displayed to the user on user workstation 102, which is initiated by financial institution 104 indicating that all fields are mandatory and/or that the user will not be able to proceed unless they provide all the mandatory data requested at 710 and 712. In other embodiments, financial institution 104 will continue to redirect the user to 708 until all mandatory information is provided by the user at 710 and 712.

At 716, financial institution 104 interacts with user verification network 122, which includes MICR module 150 for verifying MICR information. At 718, MICR module 150 verifies the MICR data provided at 710, for example, by comparing the bank number and branch transit number to information available from a third party verification service, such as the Canadian Payments Association, and the account number is verified to determine if it is an existing and valid account as well as whether or not it is the type of account that can be used to complete the account verification process and is permitted to transfer funds.

In some embodiments, if communications between financial institution 104 and user verification network 122 or MICR module 150 are unavailable, an error message can be displayed to the user at user workstation 102 indicating that the fund transfer cannot be completed and that the user should try to open an account with financial institution 104 at a later time. In some embodiments, the error message can provide the user with alternative means to transfer funds to financial institution 104 to verify the account opening, such as asking the user to go to the offices or a branch of financial institution 104 or providing a cheque to financial institution 104 linked to an account at third party financial institution 116.

At 720, if the verification of the MICR information at 718 is successful, at 724, financial institution 104 initiates a communication link with customer storage module 725 which, at 726, can store the verification and MICR information in customer database 728. In some embodiments, this information can be later retrieved for audits to show that MICR, or other account information provided by the user was successfully verified.

If, at 720, the verification of the information provided by the user is unsuccessful, MICR module 150 provides a validation error to financial institution 104, for display to the user on user workstation 102 at 722. Financial institution 104 then redirects the user to 708, and 710 and 712 can be repeated by the user. In some embodiments, if the information provided by the user is not verified by MICR module 150, or if an incomplete set of information is provided, a report can be logged by financial institution 104 which can be used to improve future fraud detection and/or security systems of financial institution 104. For example, in some embodiments, if the user at user workstation 104 is attempting to repeatedly open an account under different user profiles but from the same user workstation 102, but with each attempt the information provided by the user is unsuccessfully verified, this can be used to infer that fraudulent activities are being attempted.

At 730, if the user is opening more than one new account, the amounts to be funded can be split across the multiple accounts such that the transferred amount across each account is aggregated to one transaction.

At 732, financial institution 104 interfaces with gateway 124 to initiate a communication link to financial transaction network 114. At 734, gateway 124 interfaces with financial transaction network 114, to communicate with financial transaction network 114 through a communication channel, such as a direct communication link or through a network, such as a local area network, wide area network or the Internet. Financial transaction network 114 receives information from gateway 124 originating from financial institution 114 related to third party financial institution 116 which the user has requested as the third party financial institution to transfer funds from to authorize and verify the transaction at 210 and 212. Financial transaction network 114 at 736 provides gateway 124 with information related to the third party financial transaction, which is in turn is provided to financial institution 104, to allow financial institution 104 to direct the user using user workstation 102 to third party financial institution 116. In some embodiments, a web link or URL of third party financial institution 116 is provided to direct user workstation 102 to third party financial institution 116.

At 738, financial institution 104 is redirected to the portal of financial transaction network 114 and financial transaction network 114 provides a display to the user such that the user using user workstation 102 can initiate a fund transfer from third party financial institution 116. At 741, if the user cancels the fund transfer, for example, by selecting a cancel icon or button on a display screen of user workstation 102, at 756 financial institution 104 directs the user to 702.

If the user does not cancel the transfer of funds from third party financial institution 116 to financial institution 104 at 742, the user can select third party financial institution 116 that the user has an account and from which funds will be transferred to verify the transaction at 212. For example, the user can select third party financial institution 116 from a list displayed in user workstation 102 whereby the list can be generated at 740. In some embodiments, third party financial institution 116 that the user would like to transfer funds from may not be provided in a list of available third party financial institutions. For example, if third party financial institution 116 is not a member of financial transaction network 114 or is unable to transfer funds to financial institution 102 through financial transaction network 114, then the user may be directed to verify their account by some other means, such as by physically going to the offices or branch of financial institution 104 or by providing financial institution 104 with a cheque from an account with third party financial institution 116.

At 744, third party financial institution 116 selected by the user at 742 is provided to financial transaction network 114 and financial transaction network 114 provides “sign-in” display to the user on user workstation 102 which is associated with the user's selected account at the third party financial institution 116. At 746, if the user cancels the fund transfer, for example, by selecting a cancel icon or button on user workstation 102, at 756 financial institution 102 directs the user to 702.

If the user does not cancel the transfer of funds, at 748 the user provides log-on information to financial transaction network 114 associated with third party financial institution 116. For example, in some embodiments, the user can provide a user ID and password, or an account number and password. In other embodiments, biometric data can be provided if, for example, the user has a fingerprint scanner connected to user workstation 102 which can provide information to financial transaction network 114 that is associated with information stored in databases with third party financial institution 116 and/or financial transaction network 114 and can be used to log into the user's account with third party financial institution 116.

At 750, if the log-on is not successful, financial transaction network 798 directs user to 702. At 750, if log-on is successful, at 752, the user is logged into their account with third party financial institution 116. If, at 754, the user cancels the fund transfer, for example, by selecting a cancel icon or button on user workstation 102, at 756 financial institution 104 directs the user to 702.

If the user does not cancel the fund transfer, at 758 financial transaction network 114 displays to the user the account screen for third party financial institution 116 on user workstation 102. If, at 760, the user cancels the fund transfer, for example, by selecting a cancel icon or button on user workstation 102, at 778 financial transaction network 798 directs process 700 to 706, directing user to re-enter account information from third party financial institution 116 at 710 and 712.

If the user does not cancel the fund transfer, at 762, the user selects the account with third party financial institution 116 on user workstation 102 they have logged into and provides payment details to financial transaction network 114, for example, the account number and amount of funds to be transferred to financial institution 114 to verify the account opening at 212.

At 764, financial transaction network 114 displays to the user on user workstation 102 a request to verify the payment details provided by the user. If, at 766, the user cancels the fund transfer, for example, by selecting a cancel icon or button on user workstation 102, at 778 financial transaction network 114 directs the user to 702. If, at 768, the user indicates that they wish to select a different account or different amount of funds to be transferred, for example, by clicking a “back” or “redo” button on user workstation 102, the user is directed to 758 where financial transaction network 114 provides a display on user workstation 102 to the user to select the account they wish to transfer funds from to verify the transaction at 212.

If the user elects to proceed with the transfer of funds from third party financial institution 116, the user confirms the transaction at 770 and the confirmation is provided to financial transaction network 114 at 772.

At 774, financial transaction network 114 receives a confirmation from the user that the transaction is confirmed.

At 776 if the user did not confirm the transaction financial transactions network 114 direct financial institution 104 to 756 where the user is directed to 702.

If the user did confirm the transaction, at 780 a confirmation that the transaction was successful is received by financial transaction network 114 from third party financial institution 116. If the transaction is not successful, for example there is a lack of funds in the user's account at third party financial institution 116, the user is notified that the account opening was not successful and the user is directed to 702.

At 782, financial institution 104 initiates communications with gateway 124 which in turn initiates communications with financial transaction network 114 at 784. At 786, financial institution network 114 approves the transaction and verifies that sufficient funds are in the user's account with third party financial institution 116. In some embodiments, if insufficient funds are available in the user's account with third party financial institution 116, the account creation process can be stopped and the user can be provided with an error message on user workstation 102 indicating that insufficient funds were available and the new account is not opened.

If the fund transfer is approved by financial transaction network 114, at 786, a confirmation is provided to financial institution 104 and at 788 and financial institution 104 provides notification to the user on user workstation 102 that the fund transfer is approved. When the fund transfer is approved, the transaction is verified at 212.

Referring back to FIG. 2, at 214, once the transaction has been verified at 212, an account at the financial institution 104 is opened. In some embodiments, the user can be provided with a unique account number and details regarding how access the account, such as a user ID and password for accessing the account through an electronic portal.

At 216, funds are made available in the newly opened account and can be accessed by the user, for example, the user can withdraw some of the funds or, in some embodiments, use the funds to purchase new financial vehicles with the financial institution. In some embodiments, some or all of the funds available in the new account can be frozen, or temporarily inaccessible. For example, in such embodiments, the financial institution can put a limit of $500 for a withdrawal on the available funds in a newly opened account, even if the funds transferred into the account from third party financial institution 116 was a larger amount. In such embodiments, the frozen funds may be made available after funds have been reconciled at 218.

At 218, the financial institution 104 reconciles any funds made available at 216, such that all funds that have been transferred by new account openings from third party financial institutions have been received. In some embodiments, reconciliation of accounts can occur on a transaction by transaction basis, can occur on a daily basis, or can occur on some other timed interval. The reconciliation of funds at 218 can be provided by a financial transaction network provider that was used to verify the funds from third party financial institution 116 to the new account opened at 214.

In such embodiments, when funds are verified at 212, the financial transaction network may have provided such verification and when funds were made available at 216, such availability was made based on the verification provided at 212 without the actual transfer of money from third party financial institution 116 to the new account. In such embodiments the reconciliation of funds at 218 is when funds are physically transferred into the newly opened account at the financial institution.

In some embodiments, a financial transaction network can provide a lump sum settlement payment to the financial institution, at the end of the day, which is representative of the sum of all fund transfers performed by users opening new accounts with the financial institution. In such embodiments, reports can be provided, either written or electronic, which can provide a cross reference to the financial institution to account for how the lump sum payment was calculated, associating each fund transfer made by users opening accounts with the new account number or other unique identifier of the newly opened account. In some embodiments, these reports can be reviewed and/or evaluated (in some embodiments automatically) to assess whether the lump sum or other payments reconcile to the previous days transactions.

In some embodiments, following the reconciliation of funds at 218, additional reports can be generated, which can include information and details of the new accounts opened and funds transferred and/or reconciled as well as exception reports, error reports detailing errors logged due to users attempting, but failing, to open new accounts for that day of transactions.

The present invention has been described with regard to specific embodiments; however, it will be obvious to persons skilled in the art that a number of variants and modifications can be made without departing from the scope of the invention as described herein.

1. A method for online generating a financial account with a financial institution, comprising:
receiving over a computing network a request from a user at a user workstation at an account generation server of the financial institution to open a new financial account with the financial institution, the user not having an existing financial account with the financial institution;
receiving over the network at the account generation server identity information regarding the user, the account generation server evaluating the identity information to generate an identity confidence score;
receiving over the network at the account generation server geographic information regarding the user, the account generation server evaluating the geographic information to generate a geographic confidence score;
generating a set of user-specific questions from the received identity information, and requesting responses over the network from the user to the set of user-specific questions;
receiving over the network at the account generation server the responses from the user to the set of user-specific questions, the account generation server evaluating the responses to adjust the identity confidence score;
the account generation server generating a user overall confidence score based on the identity confidence score and the geographic confidence score; and
the account generation server evaluating whether the user overall confidence score is over a confidence threshold such that the financial account with the financial institution may be generated, and if so, the account generation server:
generating the financial account with limited status associated with the user, the financial account with limited status only permitting the deposit of funds to the limited account;
requesting the user transfer funds into the new financial account from another account with another financial institution over the network;
receiving transferred funds over the network from another account with another financial institution;
updating the financial account from limited status to regular status, wherein other functions of the financial account beyond only deposit of funds to the account are activated; and
sending a message to the user at the workstation that the new financial account has been generated and ready for use by the user.

2. The method for generating a financial account with a financial institution of claim 1, wherein the receiving transferred funds from another account with another financial institution comprises:
providing the user with the option to select the another financial institution with whom the user has an existing account, from among a selection of financial institutions;
maintaining the request for the financial account with the financial institution active at the account generation server for a predetermined period of time, while awaiting confirmation from the another financial institution that the user has authorized a transfer of funds to the financial institution, and that the another financial institution has approved the transfer of funds; and
at least one of receiving the transferred funds, or receiving a transaction confirmation for later reconciliation, from the another financial institution by the financial institution within the predetermined period of time.

3. The method for generating a financial account with a financial institution of claim 2, wherein the option to select the another financial institution with whom the user has an existing account is provided by neither the financial institution nor the another financial institution, and is provided by an intermediary entity utilized by both the financial institution and the another financial institution to permit the financial institution to receive the transferred funds from the another financial institution through the intermediary entity, wherein the at least one of receiving the transferred funds, or receiving the transaction confirmation for later reconciliation by the financial institution, is received from the intermediary entity.

4. The method for generating a financial account with a financial institution of claim 3, wherein the intermediary entity provides the transferred funds to be received by the financial institution, and receives the corresponding funds from the another financial institution.

5. The method for generating a financial account with a financial institution of claim 4, wherein the generating the user overall confidence score comprises determining a weighted average of the identity confidence score and the geographic confidence score.

6. The method for generating a financial account with a financial institution of claim 4, wherein the geographic information comprise information relating to the access location of the user, and the generating the geographic confidence score comprises determining if the access location of the user is associated with high risks of fraudulent activity.

7. The method of generating a financial account with a financial institution of claim 6, wherein the generating the identity confidence score comprises obtaining known information regarding the user based on the identity information of the user, and determining if there are inconsistencies between the known information and the received identity information.

8. The method of generating a financial account with a financial institution of claim 7, wherein the known information further identifies additional facts relating to the user than the identity information, and the generating the set of user-specific questions comprises generating the set of user-specific questions based on the additional facts relating to the user.

9. The method for generating a financial account with a financial institution of claim 8, wherein the confirmation that user has authorized the transfer of funds includes receipt of magnetic ink character recognition (MICR) information from the user.

10. The method for generating a financial account with a financial institution of claim 9, wherein the MICR information is provided to a MICR server to verify the MICR information, including that the existing account with the another financial institution as specified by the MICR information is consistent with the received identity information of the user, and that adequate funds are available in the existing account.

11. A non-transitory computer readable medium for storing a set of programming instructions for execution by, or on behalf of, an account generation server associated with a financial institution for evaluating a user for a new financial account with the financial institution and for generating the financial account, wherein the user does not have an existing financial account with the financial institution, the programming instructions for causing the account generation server to:
receive over a computing network in communication with the account generation server from the user at a user workstation communicating with the network a request to open the new financial account with the financial institution;
receive over the network at the account generation server identity information regarding the user and geographic information regarding the user and the workstation;
evaluate the identity information to generate an identity confidence score, and evaluate the geographic information to generate a geographic confidence score;
generate a set of user-specific questions from the received identity information, and requesting responses over the network from the user to the set of user-specific questions;
receive over the network the responses from the user to the set of user-specific questions, and evaluate the responses to adjust the identity confidence score;
generate a user overall confidence score based on the identity confidence score and the geographic confidence score; and
evaluate whether the user overall confidence score is over a confidence threshold such that the financial account with the financial institution may be generated, and if so:
generate the financial account with limited status at the financial institution to be associated with the user, the financial account with limited status only permitting the deposit of funds to the limited account;
request the user transfer funds into the new financial account from another account with another financial institution over the network;
receive transferred funds over the network from another account with another financial institution;
updating the financial account from limited status to regular status, wherein other functions of the financial account beyond only deposit of funds to the account are activated; and
send a message to the user at the workstation that the new financial account has been generated and is ready for use by the user.

12. The computer readable medium of claim 11, having further programming instructions for causing the account generation server to:
provide the user with the option to select the another financial institution with whom the user has an existing account, from among a selection of financial institutions;
maintain the request for the financial account with the financial institution active at the account generation server for a predetermined period of time, while awaiting confirmation from the another financial institution that the user has authorized a transfer of funds to the financial institution, and that the another financial institution has approved the transfer of funds; and
receive at least one of the transferred funds, or a transaction confirmation for later reconciliation, from the another financial institution by the financial institution within the predetermined period of time.

13. The computer readable medium of claim 12, having further programming instructions for causing the account generation server to provide the option to select the another financial institution with whom the user has an existing account to be provided by neither the financial institution nor the another financial institution, and cause the account generation server to communication with an intermediary entity in communication with the another financial institution to permit the financial institution to receive the transferred funds from the another financial institution through the intermediary entity, wherein the receive at least one of the transferred funds, or the transaction confirmation for later reconciliation by the financial institution, is received by the account generation server from the intermediary entity.

14. The computer readable medium of claim 13, having further programming instructions for causing the account generation server to generate the user overall confidence score by at least determining a weighted average of the identity confidence score and the geographic confidence score.

15. The computer readable medium of claim 14, wherein the geographic information comprise information relating to the access location of the user, and the computer readable medium having further programming instructions to generate the geographic confidence score by at least determining if the access location of the user is associated with high risks of fraudulent activity.

16. The computer readable medium of claim 15, having further programming instructions for causing the account generation server to generating the identity confidence score by at least by obtaining known information regarding the user based on the identity information of the user, and determining if there are inconsistencies between the known information and the received identity information.

17. The computer readable medium of claim 16, wherein the known information further identifies additional facts relating to the user than the identity information, and the computer readable medium having further programming instructions for causing the account generation server to generating the set of user-specific questions by at least generating the set of user-specific questions based on the additional facts relating to the user.

18. The computer readable medium of claim 17, having further programming instructions for causing the account generation server to obtain magnetic ink character recognition (MICR) information from the user in respect of the existing account at the another financial institution.

19. The computer readable medium of claim 18, having further programming instructions for causing the account generation server to provide the received MICR information to a MICR server to verify the MICR information, including that the existing account with the another financial institution as specified by the MICR information is consistent with the received identity information of the user, and that adequate funds are available in the existing account.

20. A system for evaluating a user and generating a financial account with a financial institution, comprising:
an account generation server associated with the financial institution, the account generation server having a new account module for communication with the user who does not have an existing financial account with the financial institution at a user workstation over a computing network, the new account module receiving a request from the user through the workstation and network to open a new financial account with the financial institution, whereupon the new account module obtains from the user workstation geographic information regarding the user and the user workstation, and identity information regarding the user;
a user evaluation module associated with the account generation server in communication with the new account module, the user evaluation module receiving the geographic information, evaluating the geographic information and generating a geographic confidence score therefrom, and receiving the identity information, evaluating the identity information and generating an identity confidence score therefrom, the user evaluation module further using the received identity information to generate a set of user-specific questions, and requesting responses over the network from the user to the set of user-specific questions;
the user evaluation module receiving the responses from the user to the set of user-specific questions, and evaluating the responses to adjust the identity confidence score, and generating a user overall confidence score based on the adjusted identity confidence score and the geographic confidence score; and
the user evaluation module evaluating whether the user overall confidence score is over a confidence threshold such that the financial account with the financial institution may be generated, and if so, having the account generation server to:
generate the financial account with limited status associated with the user, the financial account with limited status only permitting the deposit of funds to the limited account;
request the user transfer funds into the new financial account from another account with another financial institution over the network;
receive transferred funds over the network from another account with another financial institution;
update the financial account with limited status to regular status, wherein other functions of the financial account beyond only deposit of funds to the account are activated; and
send a message to the user at the workstation that the new financial account has been generated and ready for use by the user.
